(19) United States
(12) Patent Application Publication
(10) Pub. No.: US 2009/0041986 A1
(43) Pub. Date: Feb. 12, 2009

(54) METHOD OF MAKING HIERARCHICAL ARTICLES

(75) Inventors: Jun-Ying Zhang, Woodbury, MN (US); Jerome C. Porque, Austin, TX (US); Jennifer J. Sahlin, Minneapolis, MN (US); Terry L. Smith, Roseville, MN (US); Ding Wang, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/103,090

(22) Filed: Apr. 15, 2008

Related U.S. Application Data
(60) Provisional application No. 60/999,752, filed on Jun. 21, 2007.

(51) Int. Cl. B32B 3/02; C23F 1/02; B29C 41/42

(52) U.S. Cl. 428/156; 216/41; 216/51; 264/334; 264/300

(57) ABSTRACT

Provided is a method of fabricating hierarchical articles that contain nanofeatures and microstructures. The method includes providing a substrate that includes nanofeatures and then creating microstructures adding a layer, removing at least a portion of the layer to reveal at least a portion of the substrate.

### RELATED APPLICATIONS

This application claims priority to U.S. Provisional patent application Ser. No. 11/766,561, now U.S. Provisional Patent Application No. 60/999,752, filed Jun. 21, 2007, which is herein incorporated by reference in its entirety.

### FIELD

This application relates to methods for fabricating hierarchical articles and in particular articles that contain nanofeatures and microstructures.

### BACKGROUND

There is an interest in commercial and industrial applications to reduce the size of articles and devices. This is particularly true in the area of electronics where devices have been made smaller and smaller. Nanostructured devices, for example, can be used in articles such as flat panel displays, chemical sensors, and bioabsorption substrates. Microstructured articles have found commercial utility in, for example, electroluminescent devices, field emission cathodes for display devices, microfluidic films, and patterned electronic components and circuits. There are many applications for which it would be desirable to make hierarchical articles where smaller structures (nanofeatures, for example) are present upon larger structures (microstructures, for example). These applications include sensors, optical devices, fluidic devices, medical devices, molecular diagnostics, plastic electronics, micro-electromechanical systems (MEMS) and nano-electromechanical systems (NEMS). Also, recently there has been an interest in trying to understand and mimic adhesive mechanisms in nature such as those on the feet of the gecko. Studies have revealed that the gecko has hierarchical (micro/nanoscale) features on its feet that can stick firmly to any kind of article, but can also release effectively with minimal effort.

It is known to add nanofeatures to an existing microstructure. This has been accomplished, for example, by growing nanocrystals onto microstructured articles, nanoimprinting microstructured articles, and using interferometric lithographic techniques to make submicron or nanoscale gratings and grids on microsubstrates for optical applications. However these techniques are very costly and are not always very suitable for large area patterns or mass production.

### SUMMARY

There is a need for a more flexible method of making hierarchical articles. In this disclosure smaller features (nanofeatures) are formed before formation of larger structures (microstructures). In addition, the method can produce articles that can be used to generate final devices. This approach can provide hierarchical articles with lower cost and higher throughput than previously realized.

In one aspect, provided is a method of making a hierarchical article comprising providing a substrate that comprises a nanofeatured pattern, adding a layer to the substrate, and generating a microstructured pattern in the layer, wherein generating a microstructured pattern comprises removing at least a portion of the layer to reveal at least a portion of the substrate.

In another aspect, provided is a method of making a hierarchical article comprising providing a substrate that comprises a nanofeatured pattern, adding a layer to the substrate, and generating a microstructured pattern in the layer, wherein generating a microstructured pattern comprises removing at least a portion of the layer to reveal at least a portion of the substrate, and wherein the nanofeatured pattern is formed by a method comprising interference lithography.

In yet another aspect, provided is a method of making an article comprising providing a substrate that has a nanofeatured pattern, adding a layer to the substrate, generating a microstructured pattern in the layer, applying a polymer to the microstructured pattern, and separating the polymer from the article to produce a replica, wherein generating a microstructured pattern comprises removing at least a portion of the layer to reveal at least a portion of the substrate.

In this application:

the articles “a”, “an”, and “the” are used interchangeably with “at least one” to mean one or more of the elements being described;

the term “etching agent” refers to an agent used to remove material from a substrate and can be a wet etching agent such as, for example, an acid bath, or a dry etching agent such as, for example, reactive ions from a plasma, or a high energy laser beam;

the term “etch mask” refers to a structure that is held in proximity to or in contact with the substrate so as to allow or to prevent exposure of regions of the substrate to optical or etchant beams;

the term “etch resist” refers to a layer or layers of material that is placed on the substrate and can be patterned to form a resist pattern, which, under the etching conditions used, etches more slowly than the substrate;

the term “hierarchical” refers to constructions that have two or more elements of structure wherein at least one element has nanofeatures and at least another element has microstructures. The elements of structure can consist of one, two, three, or more levels of depth;

the terms “microstructure” or “microstructures” refer to structures that range from about 0.1 microns to about 1000 microns in their longest dimension. In this application, the ranges of nanofeatures and microstructures overlap;

the terms “nanofeature” or “nanofeatures” refer to features that range from about 1 nm to about 1000 nm in their longest dimension. The nanofeatures of any article of this application are smaller than the microstructure generated on the article;

the term “negative relief image” refers to a three-dimensional replication of an article that contains an inverted topological structure of the original article;

the terms “pattern” or “patterns” refer to a configuration or configurations that can include regular arrays or random arrays of features or structures or a combination of both; and

the term “resist” refers to a layer or layers of material that is placed on the substrate to selectively allow an etching agent to pass through in a patterned manner.

The above summary of the present invention is not intended to describe each disclosed embodiment of every implementation of the present invention. The Figures and the detailed description which follow more particularly exemplify illustrative embodiments.

### BRIEF DESCRIPTION OF THE DRAWINGS

FIGS. 1a-1g illustrate an embodiment of the invention in which nanoparticles are used as an etch mask to form nanofeatures.

FIGS. 2a-2e illustrate an embodiment of the invention in which nanofeatures are generated by interference lithography.

FIGS. 3a-3f illustrate an embodiment of the invention that uses photolithography and reactive ion etching to produce microstructure on the nanofeatures of FIG. 2e.

FIGS. 4a-4c illustrate an embodiment of the invention that uses photolithography through a contact mask to produce microstructure on the nanofeatures of FIG. 2e.

FIGS. 5a and 5b illustrate an embodiment of the invention in which excimer laser ablation through an aperture mask is used to produce the microstructure on the nanofeatures of FIG. 2e.

FIG. 6 is a photomicrograph of Example 2.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Provided is a method of making a hierarchical article that includes providing a substrate that has a nanofeatured pattern, adding a layer to the substrate, and generating a microstructured pattern in the layer, wherein generating a microstructured pattern comprises removing at least a portion of the layer to reveal at least a portion of the substrate.

The hierarchical article can be used directly for its intended purpose, or the article can be used as a mold to generate a replica by, for example, casting a polymer onto the article, solidifying the polymer and separating the solidified polymer from the article to form a replica that has a negative relief image of the original hierarchical article. This replica can in turn be used as a mold to replicate the original article. With application of appropriate protective coatings and/or release coatings, many replicas can be made from the original hierarchical article, many molds can be made from the original replica or replicas or many more replicas can be made from the second generation or daughter molds. The molds can then be used for their intended purpose or can be used to make multiple additional replicas for mass production.

The substrate can be selected from a variety of materials. These materials include polymeric films such as, for example, polyimide or polymethylmethacrylate, or inorganic materials such as glasses, silicon wafers, and silicon wafers with coatings. The coatings on the silicon wafers can include polymer film coatings such as, for example, polyimides or urethane acrylates, or can include inorganic coatings such as, for example, an SiO₂ coating. Additionally the substrate can be a porous glass as disclosed by Wiltzius et al., Phys. Rev. A., 36(6), 2991, (1987) entitled “Structure of Porous Vycor Glass”; a polymer surface dewetted by a thin polymer film as described by Higgens et al., Nature, 404, 476 (2000) entitled “Anisotropic Spinodal Dewetting As a Route to Self-assembly of Patterned Surfaces”, a mixed ionic crystal such as described in Ringe et al, Solid State Ionics, 177, 2473 (2006) entitled “Nanoscaled Surface Structures of Ionic Crystals by Spinodal Composition”, or a light sensitive substrate. Light sensitive substrates can include photosensitive polymers, ceramics, or glasses.

The substrate can have a nanofeatured pattern that includes nanofeatures. The pattern can be in the form of a regular array of nanofeatures, a random arrangement of nanofeatures, a combination of different regular or random arrangements of nanofeatures, or any arrangement of nanofeatures. The nanofeatured pattern can be formed directly in the substrate or in an added layer. Additionally, the nanofeatured pattern can be formed as a part of the substrate.

The nanofeatured pattern can be formed directly in the substrate. The pattern can be generated using patterning techniques such as anodization, photoreplication, laser ablation, electron beam lithography, nanoimprint lithography, optical contact lithography, projection lithography, optical interference lithography, reactive ion etching, ion beam etching, and inclined lithography. The pattern can then be transferred into the substrate by removing existing substrate material using subtractive techniques such as wet or dry etching, if necessary. The nanofeatured pattern can be transferred into the substrate by wet or dry etching through a resist pattern. Resist patterns can be made from a variety of resist materials including positive and negative photoresists using methods known by those skilled in the art. Wet etching can include, for example, the use of an acid bath to etch an acid sensitive layer or the use of a developer to remove exposed or unexposed photoresist. Dry etching can include, for example, reactive ion etching, or ablation using a high energy beam such as, for example, a high energy laser, or ion beam.

Alternatively, a layer or layers of nanoparticles coated on the top of the substrate can act as a resist pattern by preventing exposure of the substrate to radiation or etching where the nanoparticles reside, but allowing exposure of the resist in the areas not in direct line of the nanoparticles. The nanoparticles can be dispersed and can, optionally, be combined with a binder or article-modified to make them immobile on the article of the added layer. Nanoparticles that can be useful as an etch mask include oxides such indium-tin oxide, aluminum oxide, silicon dioxide, titanium dioxide, zirconium dioxide, tantalum oxide, hafnium oxide, niobium oxide, magnesium oxide, zinc oxide, indium oxide, tin oxides, and other metal or metalloid oxides. Other useful nanoparticles include nitrides such as silicon nitride, aluminum nitride, gallium nitride, titanium nitride, carbon nitride, boron nitride and other nitrides known by those skilled in the art to be nanoparticles. It is also possible to use metal nanoparticles as an etch mask. Metal nanoparticles include nanoparticles of aluminum, copper, nickel, titanium, gold, silver, chromium, and other metals. Indium-tin oxide (ITO) nanoparticles have been found to be disperable in isopropanol and adherent to polyimide films and can be used as an etch mask without modification or the addition of other additives. Other nanoparticles can be dispersible with the addition of article modification groups as known by those skilled in the art.

It is also contemplated that the nanofeatured pattern can be formed on the substrate by coating the substrate with metal such as, for example, gold, silver, aluminum, chromium, nickel, titanium, and copper, annealing the metal to form islands of metal and then using the islands of metal as an etch mask for the substrate itself. Etching of the substrate can be accomplished with any of the etching techniques mentioned earlier in this application. It is also within the scope of this disclosure to form the nanofeatured pattern using chromonics as disclosed, for example, in U.S. Ser. No. 11/626,456 (Mahoney et al.), which is incorporated herein by reference, as an etch mask.

The nanofeatured pattern can also be formed by direct modification of the substrate without the addition of any additional material. For example laser ablation can remove selected areas of the substrate to form nanofeatures. If the substrate is light-sensitive then it can be possible to form the nanofeatured pattern by exposing the photosensitive substrate by optical projection or contact lithography and then developing. Alternatively, interference photolithography can be used to generate a nanopattern in a photosensitive material. Anodization of a conductive substrate can also be used to form the nanofeatured pattern.

Patterns can be formed directly in the substrate by using a high energy beam to ablate the substrate. The pattern can be defined by rastering the beam, or by using an etch mask to protect parts of the substrate. The etch mask can be formed, for example, from an etch resist. This approach can be particularly useful for forming nanofeatured patterns subtractively in some polymer substrates such as, for example, polyimide.

The nanofeatured pattern can also be formed by adding a material to the substrate. The material can include the nanofeatured pattern when it is added to the substrate, or the material can be added to the substrate and then subsequently have the nanofeatured pattern generated in it. The nanofeatured pattern can be formed in the material before it is added to the substrate. The nanofeatured pattern can be added to the material subtractively using the methods herein. The nanofeatured pattern can also be cast into the added material. For example, a replica with a negative relief article of the nanofeatured pattern can be used to form the nanofeatured pattern in the material. In this case, the material can be a thermoplastic material that flows at a high temperature and then becomes solid at room temperature or at use temperature. Alternatively, the material can be a thermoset and can be cured using a catalyst, heat, or photoexposure depending upon its chemistry. When the material is added to the substrate it can be added as a solid. The material can be added to the substrate by lamination or by adding a thin adhesive material. Materials that can be used for this purpose include thermoplastic polymers that flow at elevated temperatures but not at lower temperatures such as room temperature. Examples of thermoplastic polymers that can be used include acrylics; polyolefins; ethylene copolymers such as polyethylene acrylic acid; fluoropolymers such as polytetrafluoroethylene and polyvinylidene fluoride; polyvinylchloride; ionomers; ketones such as polyetheretherketone; polyamides; polycarbonates; polyesters; styrene block copolymers such as styrene-isoprene-styrene; styrene butadiene-styrene; styrene acrylonitrile; and others known to those skilled in the art. Other useful materials for forming a substrate with nanofeatures include thermosetting resins such as, for example, polydimethylsiloxanes, urethane acrylates and epoxies. An example of thermosetting resins can be a photocrosslinkable system, such as a photocurable urethane acrylate, that forms a polymeric substrate with nanofeatures upon curing.

When addition of a material to the substrate is used to produce the nanofeatured pattern, a number of materials can be used. For example, a photoresist (negative or positive) can be added to the substrate. The photoresist can be exposed to light passing through a photomask or projected through a lens system to produce nanofeatures. Additionally interference lithography can be used to produce the nanofeatured pattern. Interference lithography is discussed, for example, in S. R. J. Brueck, “Optical and Interferometric Lithography-Nanotechnology Enablers”, Proceedings of the IEEE, Vol. 93 (10), October 2005. The exposed (positive photoresist) or unexposed (negative photoresist) areas can then be removed by using a developing solution to dissolve the undesired photoresist. The resist can then be hardened by physical or chemical means for use in later steps. It is also contemplated that the photoresist can be exposed by directly writing with a rastered or digitally-pulsed laser beam, or by interference lithography as is known in the art. The developed photoresist can then be hardened and used as described herein. Useful photoresists include negative photoresists such as UVN 30 (available from Rohm and Haas Electronic Materials, Marlborough, Mass.), and FUTURREX negative photoresists (available from Futurrex, Franklin, N.J.), and positive photoresists such as UV5 (available from Rohm and Haas Electronic Materials) and Shipley 1813 photoresist (Rohm and Haas Electronic Materials). Other photopolymers can be used to generate the nanofeatures. Any photopolymer system known to those skilled in the art can be used that can be used to form nanofeatures upon exposure to radiation (UV, IR, or visible).

The resist pattern produced by exposure and development of the photoresist materials, can also be transferred into the substrate by direct removal of unwanted materials by dry etching using the photoresist as resist pattern. For example, reactive ion etching can be used to remove parts of the substrate or materials added to the substrate in a manner so as to generate nanofeatures. In reactive ion etching, a reactive gas species, such as CF₄ or SF₆ is added to a reaction chamber. A plasma is generated by applied radio frequency (RF) potentials. This causes some of the gas molecules to be ionized. These ionized particles can be accelerated towards various electrode articles and can etch or dislodge molecules from the article they impinge upon. Typically, reactive ion etching is accomplished through an etch mask or directly using a rastered or digitally controlled beam.

Alternatively, a thin metal layer can be deposited on the substrate, the photoresist can be deposited on the metal, and the photoresist can be patterned, then the resist pattern can be transferred into the metal by wet etching. In this way a metal pattern can be generated that can serve as a resist pattern for dry etching of the substrate. Consequently a large etch rate difference between the (metal) resist pattern and the substrate can be achieved.

As another example, an electron beam (e-beam) can be used to create a resist pattern in an e-beam resist. For example, poly(methyl methacrylate), available from MicroChem, Corp., Newton, Mass.), can be added to the substrate and an etch mask that includes nanofeatures can be produced by development of the resist. Subsequently the substrate can be reactive ion etched through the resist pattern.

The provided method of making a hierarchical article includes adding a layer to a substrate that has a nanofeatured pattern that includes nanofeatures. This added layer is the one from which or into which microstructures are fabricated. The microstructures can be fabricated by any of the techniques described herein. The added layer can be a photopolymer, a non-photosensitive polymer, deposited glass, deposited metal or a deposited semiconductor. The layer can be added, for example, by coating, lamination, deposition, printing, or any other techniques known to those skilled in the art. The added layer can be an etch resist. The resist can be patterned or patternable. The resist can be a photoresist. Exemplary coating techniques to add the layer can include, for example, solution coating, dispersion coating, hot-melt coating, knife coating, and dip coating. Lamination can include, for example, heat lamination, photochemical lamination, and also can include article modification of the substrate or the layer or both. Post-lamination annealing can be done, if desired, to enhance adhesion. Vapor deposition techniques such as, for example, evaporative vapor deposition, sputtering, chemical vapor deposition, or plasma enhanced chemical vapor deposition are methods that can be used to add a layer to the substrate and are within the scope of this disclosure.

After addition of the layer, a microstructured pattern can be generated in the layer. The microstructured pattern can be formed by removing at least a portion of the layer to reveal at least a portion of the substrate that includes nanofeatures. The microstructured pattern can be formed in the layer by any manner known by those in the art. The microstructured pattern can be generated photochemically by using a photoresist or other photopolymer system. The patterned exposure can be made through a photomask in contact with the resist layer, by projection of a radiative pattern onto the resist layer, by writing a pattern with a laser into the resist layer, by interference lithography, or by any other means known by those of skill in the art. If the photoresist is a positive photoresist the exposed areas can be rendered soluble in a developer by the exposure and the exposed portions can be removed to reveal the substrate. If the photoresist is a negative photoresist, the exposed areas can be rendered insoluble in a developer and the unexposed portions of the photoresist can be removed to reveal the substrate. Other photopolymers that can be used to form the microstructures include, for example, urethane acrylates, and epoxies. The microstructure can also be formed subtractively using patterned etching or patterned ablation with or without an etch mask as described herein for the formation of nanofeatures. Useful materials for etching or ablating include deposited polymers, glasses, metal oxides, metals, and semiconductors. Polymers useful in this invention can include polyimides, urethane acrylates, and epoxies. Deposited glass can include, for example, SiO₂, and BPSG (borophosphate silicated glass). Deposited metal can include, for example, aluminum, silver, gold, chromium, and nickel. Deposited semiconductor layers can include, for example, zinc oxide, silicon, boron nitride, zinc sulfide, cadmium sulfide, and other inorganic semiconductors. Deposited semiconductors layers can also include organic semiconductors such as pentacene, pentacene derivatives, or other organic semiconductors such as those disclosed in U.S. Pat. Nos. 6,998,068 and 7,109,519 (both to Gerlach), U.S. Pat. No. 7,211,679 (Gerlach et al.), and U.S. Ser. No. 11/278,222 and 11/379,642 (both Zhu et al.) which are hereby incorporated by reference.

The microstructures can be formed at right angles (900 or normal) to the plane of the substrate surface or a contact mask, if one is used. Alternatively, the microstructure can be produced at an angle other than normal to the plane of the substrate surface or the contact mask. If the microstructure is at an angle other than 900 the resulting structures can be referred to as “angled posts”. Angled posts can be made using methods such as inclined lithography. Inclined lithography is described for example, in Beuret et al., IEEE Micro Electro Mechanical Systems, Oiso, Japan, January 1994, pp. 81-85, and Han et al., Sensors and Actuators A, 111, 14-20 (2004). Angled posts can be made at angles of less than about 85.5°, less than about 78°, less than about 70°, less than about 65°, less than about 60° or even less than about 45° to the plane of the substrate.

It is also contemplated that the microstructure can be formed by a photopolymer with a two-photon initiation system such as those disclosed in, for example, U.S. Pat. No. 6,750,266 (Bentsen et al.) which is incorporated herein by reference. With a two-photon system polymerization, the microstructures can be formed by polymerizing the microstructured features using a two-photon fabrication system such as that disclosed in, for example, U.S. Ser. No. 11/531,836 (Faklis et al.) which is incorporated herein by reference. In such a system direct photo-crosslinking of three-dimensional objects is possible and the microstructure can be directly written into the photopolymer. As with conventional photochemical generation, the unpolymerized portion of the two-photon system is removed by use of an appropriate solvent to reveal at least a portion of the original substrate.

The microstructured pattern can also be generated subtractively by dry etching the added layer using, for example, a reactive ion beam, a high energy laser beam, or an excimer laser. Excimer laser ablation is described in more detail in U.S. Pat. No. 6,285,001 (Fleming et al.) which is incorporated herein by reference. The beams can be patterned by passing them through a photomask or an aperture mask. The photomask can be a solid object such as a glass plate that is transparent to the energy beam but has an opaque (to the frequency of the energy) pattern. Alternatively the photomask can be a solid object that has patterned holes in it. In this case the energy beam is allowed to pass through the holes but is blocked by the object. It is important when using a photomask that the energy beam does not rapidly destroy the mask before etching is completed. Patterned portions of the added layer can also be removed by direct exposure to a high energy beam by rastering or digitally pulsing the beam to move it to locations where removal of the layer is desired.

In another aspect, what is disclosed is a method of making a hierarchical article comprising providing a substrate that has a nanofeatured pattern, adding a layer to the substrate, generating a microstructured pattern in the layer, applying a polymer to the microstructured pattern, and separating the polymer from the article to produce a replica wherein generating a microstructured pattern comprises removing at least a portion of the layer to reveal at least a portion of the substrate. Polymers useful for forming the replica can include thermoplastic polymers and thermosetting polymers known to those skilled in the art. Thermoplastic polymers can include materials that soften or melt above room temperature but that are rigid and can hold structure when at or below room temperature. Some thermoplastic polymers that can be useful to produce replicas include, for example, polymethylmethacrylate (PMMA), polycarbonate (PC), polystyrene (PS), polyvinylchloride (PVC), polypropylene (PP), polyethylene terephtalate (PET), polyetheretherketone (PEEK), polyamide (PA), polysulfone (PSU, very brittle polymer), polyvinylidenefluoride (PVDF), and polyoxymethylene (POM, very soft and elastic polymer).

Thermosetting polymers can also be useful for forming replicas. Thermosetting polymers that are useful include polysiloxanes (such as polydimethyldisiloxane (PDMS)), polyimides (made from curing of polyamic acid), and urethane acrylates. For the replication of nanofeatures and microstructures, the polymers used to form the replica can have low viscosity. This can allow the polymer to flow into and around the small features of the article. It can be useful to apply the polymer to the article under vacuum so that air entrapment between the article and the polymer is minimized.

It can be advantageous to apply a release coating to the hierarchical article before forming a replica. If the hierarchical article is made from SiO₂, SiN, or other inorganic or polymeric materials, the article can be coated with a fluorosilane release agent such as, for example, trimethychlorosilane or fluorinated siloxanes such as those disclosed in U.S. Pat. No. 5,851,674 (Pellerite et al.). Also useful for this purpose are hexafluoropolyprolylene oxide derivatives such as those disclosed in U.S. Pat. No. 7,173,778 (Jing et al.). These disclosures are hereby incorporated by reference.

Alternatively, the article can be metallized with, for example, a thin layer of nickel that has been vapor deposited or deposited by electroless plating. If the article is metallized it can also be advantageous to put a release agent on the metallized article to enhance the release of the polymers that form the replica. For example, the article can be coated with a release layer such as a fluorinated phosphonic acid as disclosed in U.S. Pat. No. 6,824,882 (Boardman et al.) or perfluoropolyether amide-linked phosphonates such as those disclosed in U.S. Pat. Publication No. 2005/0048288 (Flynn et al). It is also contemplated that the hierarchical article can be protected by coating with diamond-like glass as disclosed, for example in U.S. Pat. No. 6,696,157 (David et al.). These disclosures are hereby incorporated by reference.

The replica-forming polymers can be placed in contact with the hierarchical article (with or without a protective coating), cured by any of a variety of means including heat, moisture or radiation, and then separated from the article to produce a negative relief image (replica) of the article. The replicas can be used to produce secondary or daughter molds of the original article.

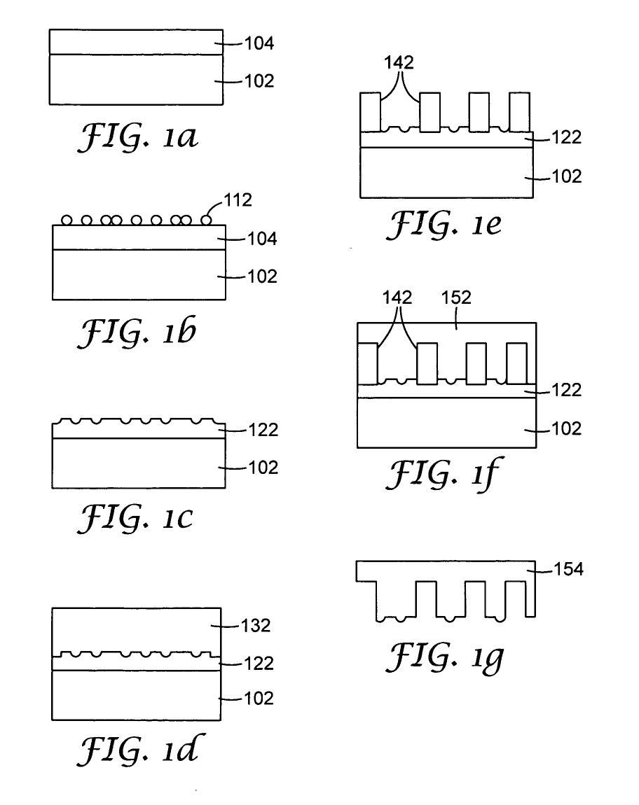

The figure sequences 1a-1g, 2a-2e, 3a-3f, 4a-4c, and 5a-5b illustrate various embodiments of a method for making a hierarchical article that include providing a substrate that has a nanofeatured pattern, adding a layer to the substrate, and generating a microstructured pattern in the layer, wherein generating a microstructured pattern comprises removing at least a portion of the layer to reveal at least a portion of the substrate. FIG. 1a provides substrate 102 that is a silicon wafer, upon which is coated polymeric layer 104 (polyimide). Nanoparticles 112 are coated from a dispersion on the added layer 104. After drying, the result is shown in FIG. 1b and includes substrate 102, coated layer 104, and nanoparticles 112 on the polymeric layer 104. The intermediate shown in FIG. 1b is then subjected to etching, for example, reactive ion etching. The layer 104 is etched by the reactive ion beam in locations where it is directly exposed to the beam. However the dispersed nanoparticles 112 act as an etching mask and shield the layer 104 from etching where they are present. The result is shown in FIG. 1c and includes substrate 102 with etched layer 122 comprising nanofeatures (in the form of nanopits where the reactive ion beam is not screened by the nanoparticles and etches away part of substrate 104 to form etched layer 122). As shown in FIG. 1d, a negative photoresist 132 is then coated over the etched layer 122. The photoresist 132 is exposed though a photomask that includes a microstructured pattern. The photoresist is developed in a developer solution and the soluble portions removed. The result is the hierarchical article shown in FIG. 1e comprising substrate 102 with etched layer 122 (containing nanofeatures) and a microstructured pattern with elements 142.

As shown in FIG. 1f, replication material 152 is then cast over the article shown in FIG. 1e. After curing (by using heat, moisture, or actinic radiation), the replica 154 as shown in FIG. 1g is separated from the replica. Replica 154 has microstructure with nanofeatures as shown.

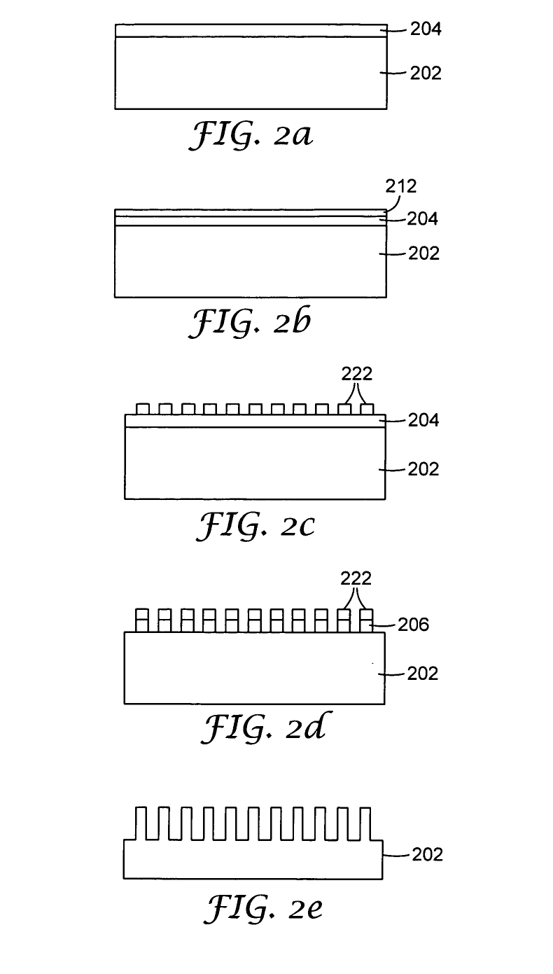

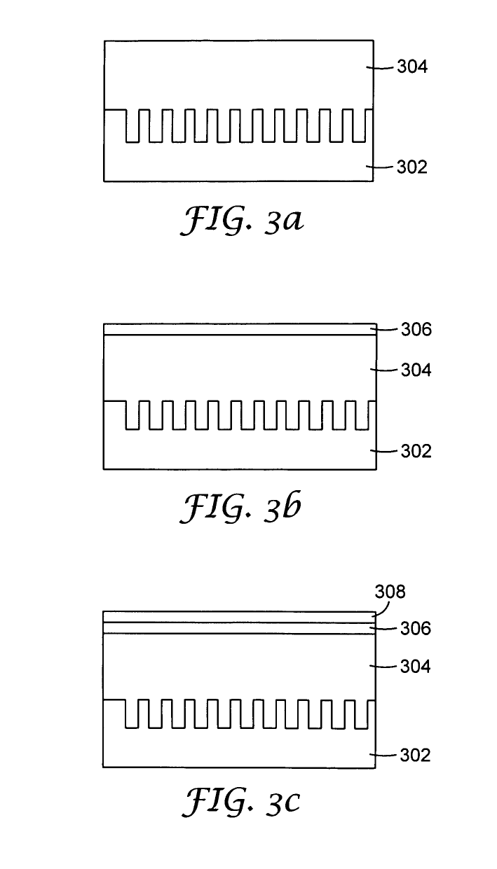

FIGS. 2a-2e illustrate a method that generates the nanofeatures by interference lithography. These nanofeatures are used in the sequences shown in FIGS. 3a-3f, 4a-4c and 5a-5b to generate hierarchical articles or replicas.

In FIG. 2a-2e, a thin aluminum layer 204 is deposited upon the substrate 202 which is made from SiO₂ deposited upon a silicon wafer. A positive photoresist 212 is then coated onto aluminum layer 204 as shown in FIG. 2b. Two exposures are made at right angles to form three-dimensional nanofeatures by interference lithography. The photoresist 212 is developed and the exposed areas are removed as shown in FIG. 2c to produce an article that includes substrate 202, aluminum layer 204 and a layer of undeveloped photoresist 206 that has nanofeatures 222.

In the next step, shown in FIG. 2d, the aluminum layer 204 that is not covered by the photoresist 222 is wet-etched to remove aluminum and to expose the substrate 202. Nanofeatures are etched into the substrate as shown in FIG. 2e. Reactive ion etching removes the photoresist and the SiO₂ substrate but is resisted by the aluminum 206 which acts as an etching mask. The result, shown in FIG. 2e, is a SiO₂ substrate that includes nanofeatures. In FIG. 2e the etching has also eroded the aluminum layer away. The etch rate of the aluminum is much slower than that of the substrate. The sequence of FIGS. 3a-3f illustrates an embodiment of the method of this disclosure to produce nanofeatures using interference lithography as shown in the sequence of FIGS. 2a-2e and uses lithography and reactive ion etching to produce microstructure on the nanofeatures. As shown in FIG. 3a, polymeric resin layer 304 is coated onto nanofeature-containing substrate 302 and is cured by heat. A thick layer of aluminum 306 is coated on the cured resin 304 as shown in FIG. 3b. A positive photoresist 308 is then coated onto the aluminum layer as shown in FIG. 3c. Lithography by exposure through a contact mask is used to pattern the photoresist 310 by forming holes 312 as shown in FIG. 3d. After development of the photoresist (removal of the exposed areas) the exposed aluminum 306 is wet-etched away to give the article shown in FIG. 3e. FIG. 3e has substrate 302 with nanofeatures that has cured resin 304 on top of the nanofeatures and has patterned photoresist 309 with patterned aluminum 310 on top. The pattern is then transferred into the resin 304 using reactive ion etching to remove exposed resin. The resulting article is shown in FIG. 3f. This article can be used to produce replicas as described above.

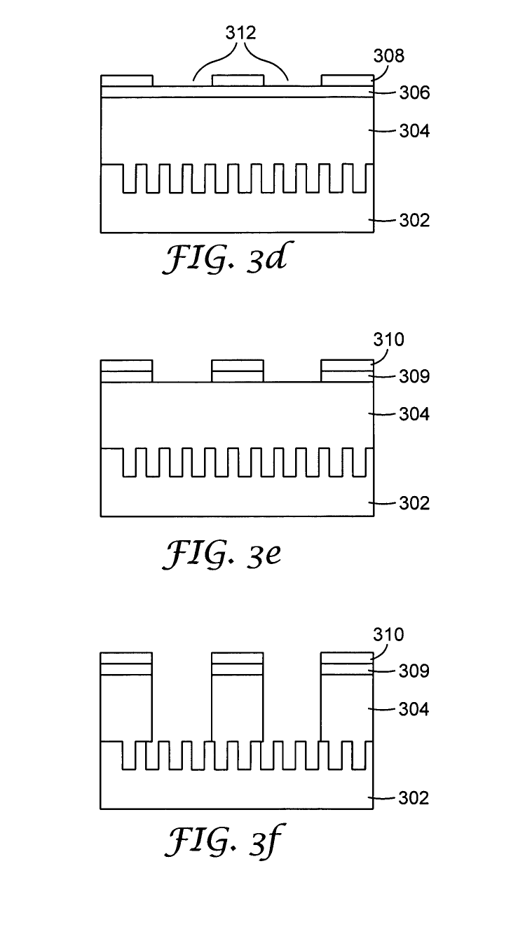

Another embodiment of the invention is illustrated in the sequence of FIGS. 4a-4c. An SiO₂ or nickel substrate that includes nanofeatures 402 (from FIG. 2e, FIG. 3a, or FIG. 4a) is filled with a positive photoresist 404. The photoresist is exposed through contact mask 410. The exposed photoresist 404 is then removed by exposure to developer. The result is a hierarchical article that has substrate 402 with nanofeatures and cured photoresist microfeatures 406.

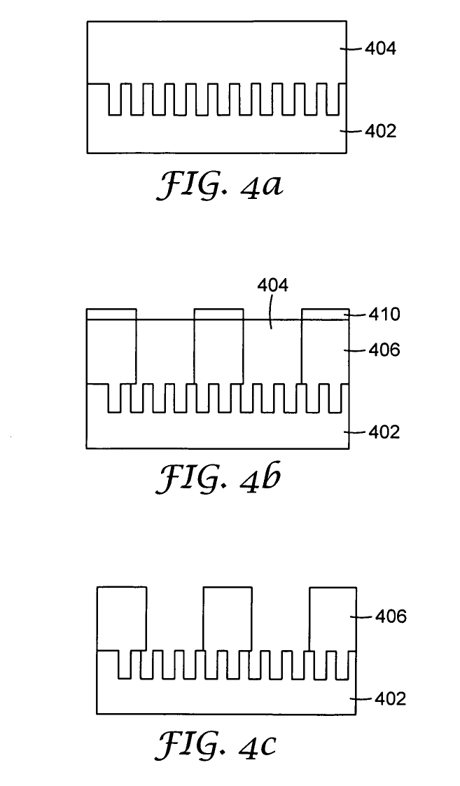

An additional embodiment that is used to make hierarchical articles is shown in the sequence of FIGS. 5a-5b. An SiO₂ or nickel substrate that includes nanofeatures 502 (from FIG. 2e or FIG. 3a) is used as is or is coated with a protective coating of nickel by plating processes disclosed earlier and known by those skilled in the art. A resin 504, for example a curable urethane acrylate, is poured into the substrate with nanofeatures 502 and cured thermally or photochemically. Excimer laser ablation through mask 506 is used to produce the microstructure 505 as shown in FIG. 5b. This structure is then used as a mold to produce replicas as disclosed above. In this application, although the term replica and mold can be used interchangeably depending upon whether the hierarchical article or its replica is used as the final product, it is assumed that the original hierarchical article is a negative mold used to prepare positive replicas.

The hierarchical articles of this invention can be used for a variety of purposes. They can have utility as sensors, optical devices, fluidic devices, medical devices, molecular diagnostics, plastic electronics, micro-electromechanical systems (MEMS), and nano-electromechanical systems (NEMS). They can be used as physical adhesives or as micro or nano brushes for use in the microelectronics field.

Objects and advantages of this invention are further illustrated by the following examples, but the particular materials and amounts thereof recited in these examples, as well as other conditions and details, should not be construed to unduly limit this invention. Unless otherwise stated or apparent, all materials used in the following examples are commercially available.

### EXAMPLES

### Example 1

This example used a combination of conventional optical lithography and reactive ion etching using nanoparticles as an etching mask. This example followed the scheme illustrated in FIGS. 1a-1g.

A 4 μm thick layer of polyimide (PI 5878G, obtained from HD MicroSystems, Parlin, N.J.) was coated onto a silicon wafer (obtained from Montco Silicon Technologies, Inc., Spring City, Pa.). The polyimide-coated wafer was then dipped into a suspension of 1 wt % indium-tin oxide (ITO) nanoparticles (available from Advanced Nano Products Co., Ltd, Chungcheonbuk-do Korea) in a solution of 1:1 (by volume) isopropanol:water.

The silicon wafer with the coating of ITO nanoparticles was then etched by reactive ion etching (RIE) to create a relief pattern on the polyimide layer. The RIE was done using a Model PLASMA LAB System 100, available from Oxford Instruments, Yatton, UK. The radio frequency (RF) power was 60 watts, the pressure was 15 mTorr, the ICP power was 1900 watts and the gas flow was 2 sccm C₄H₈ and 20 sccm O₂. The etching time was 50 seconds.

After etching, a 15 μm thick layer of SU-8 negative photoresist (MicroChem Corp., Newton, Mass.) was coated on the polyimide by spin coating at 2000 rpm for 40 seconds. The photoresist was nanofeatured, baked at a temperature of 65° C. for 2 minutes and then at 95° C. for 2 minutes. Following the baking steps, the photoresist was cooled to room temperature and then exposed using an optical lithography system (obtained from Neutronix Quintal Corp., Morgan Hill, Calif.). After exposure, a post-exposure bake (65° C. for 2 minutes and then 95° C. for 2 minutes) was performed to selectively crosslink the exposed portions of the photoresist. The photoresist was developed in propylene glycol methyl ether acetate (PGMEA, available from MicroChem Corp.). This resulted in a hierarchical multistructured article. A replica was then formed from this master by replication with polydimethylsiloxane (SYLGARD 184 Silicone Elastomer Kit, available from Dow Corning, Midland, Mich.). The polydimethylsiloxane was poured on the patterned, cured photoresist and then was cured on a hot plate (80° C. for 1 hour). After the curing the polydimethylsiloxane replica was peeled off the photoresist master to yield a multistructured replica of the original article.

### Example 2

Small features were made by interference lithography using a 244 nm frequency doubled argon laser with an output of 300 mW (Sabre FreD Laser, available from Coherent Inc., Santa Clara, Calif.) in a positive photoresist (Shipley UV5 resist, available from Rohm and Haas Electronic Materials Inc., Marlborough, Mass.) that was coated on a silicon wafer that had an SiO₂ layer deposited on it by plasma enhanced chemical vapor deposition using a Model PLASMALAB System 100 available from Oxford Instruments, Yatton, UK. Two serial exposures were made (the second exposure was made after rotating the substrate 90 degrees). The resist pattern was transferred by reactive ion etching into the SiO₂ layer by using an aluminum mask as follows.

The silica layer deposited SiO₂ on a Si wafer was coated with aluminum. Because of the strong reflectivity of aluminum, an anti-reflective coating (ARC UV-112 Brewer Science) was coated on the aluminum before applying photoresist in order to avoid degradation of the pattern due to reflected light. A negative photoresist (Shipley UVN 30, T=0.5 μm) was coated over the ARC, and the photoresist was exposed using optical interference lithography. To fabricate the square array of nanofeatures, two exposures were performed, with the wafer rotated by 90 degrees between exposures. A cross-hatch exposure was formed from the linear diffraction pattern produced by interference lithography. After the interference lithography exposure and development of the photoresist, the ARC layer was removed by reactive ion etching and the aluminum was patterned by wet etching through the photoresist pattern. Finally nanofeatures were etched into the SiO₂ using reactive ion etching through the Al pattern.

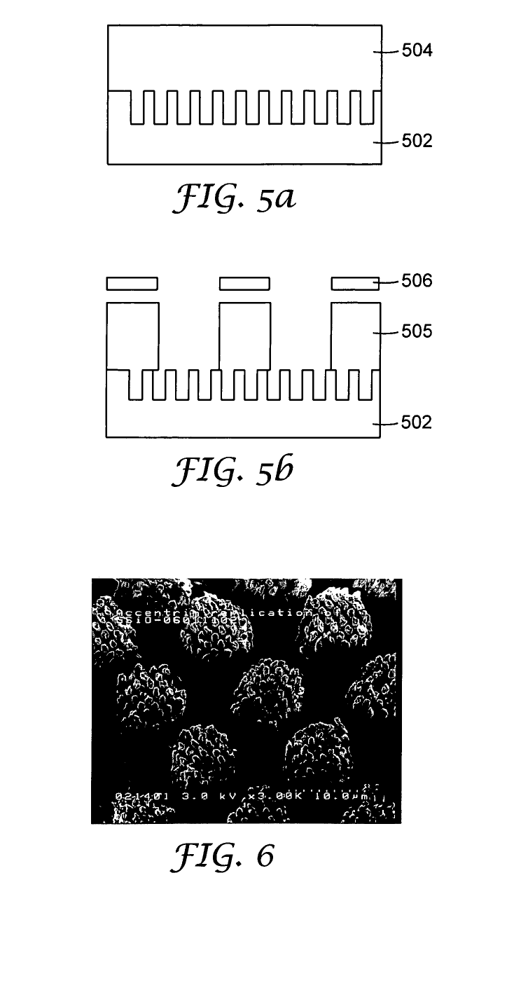

A 21 μm layer of a urethane acrylate (PHOTOMER 6210, available from Cognis, Co., Cincinnati, Ohio) was coated on the nanofeatures. A thick layer of aluminum (2000 nm) was coated on the urethane acrylate layer by electron beam evaporation and then a photoresist (Shipley PR1813, available from Electronic Materials, Inc.) was coated on top of the stack. Standard contact mask lithography was used to pattern the photoresist to generate a 10 μm hole pattern. A wet etch using a mixed solution containing 500 ml H₄PO₃, 19.4 ml HNO₃, 96.8 ml glacial acetic acid, 32.2 ml water, and 0.6 ml ethylene glycol was performed to transfer the pattern in the photoresist into the aluminum layer. The aluminum microstructure was then transferred into the urethane acrylate by reactive ion etching. A UV-curing acrylate resin containing PHOTOMER 6210 and SARTOMER 238 (75:25 by weight) (both available from Sartomer, Co., Warrington, Pa.) was used to replicate the hierarchical structure which is shown in the photomicrograph in FIG. 6.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A method of making a hierarchical article comprising:
providing a substrate that comprises a nanofeatured pattern;
adding a layer to the substrate; and
generating a microstructured pattern in the layer,
wherein generating a microstructured pattern comprises removing at least a portion of the layer to reveal at least a portion of the substrate.

2. The method of claim 1 wherein the nanofeatured pattern is made by a process selected from anodization, photoreplication, laser ablation, electron beam lithography, nanoimprint lithography, optical contact lithography, projection lithography, inclined lithography, optical interference lithography, reactive ion etching, and ion beam etching.

3. The method of claim 1 wherein the nanofeatured pattern is generated by a method comprising etching using an etch resist.

4. The method of claim 3 wherein the etch resist comprises nanoparticles.

5. The method of claim 4 wherein the nanoparticles comprise a metal oxide, a metal nitride, a metal, or a combination thereof.

6. The method of claim 1 wherein the layer comprises a resist.

7. The method of claim 1 wherein generating a microstructured pattern comprises etching.

8. The method of claim 1 wherein the method comprises generating the microstructured pattern at an angle other than 90° to that of the plane of the substrate.

9. A method of making a hierarchical article comprising:
providing a substrate that comprises a nanofeatured pattern;
adding a layer to the substrate; and
generating a microstructured pattern in the layer,
wherein generating a microstructured pattern comprises removing at least a portion of the layer to reveal at least a portion of the substrate, and wherein the nanofeatured pattern is formed by a method comprising interference lithography.

10. A method of making an article comprising:
providing a substrate that has a nanofeatured pattern;
adding a layer to the substrate;
generating a microstructured pattern in the layer;
applying a polymer to the microstructured pattern; and
separating the polymer from the pattern to produce a replica,
wherein generating a microstructured pattern comprises removing at least a portion of the layer to reveal at least a portion of the substrate.

11. The method of claim 10 further comprising adding a release coating to the article.

12. The method of claim 11 wherein the release coating comprises a fluorosilane.

13. The method of claim 10 further comprising adding a protective coating to the article.

14. The method of claim 13 wherein the protective coating is selected from a metal and diamond-like glass.

15. The method of claim 14 wherein the protective coating comprises a metal.

16. The method of claim 15 further comprising adding a release coating.

17. The method of claim 16 wherein the release coating comprises a fluorinated phosphonic acid.

18. The method of claim 10 further comprising curing the polymer.

19. The method of claim 18 wherein the polymer comprises a polydimethylsiloxane.

20. A replica made from using the method of claim 10.
